(19) United States
(12) Patent Application Publication
(10) Pub. No.: US 2004/0028959 A1
(43) Pub. Date: Feb. 12, 2004

(54) Fuel cell separator manufacturing method and fuel cell separator

(76) Inventors: Ayumi Horiuchi, Okazaki-shi (JP); Takenori Ikeda, Okazaki-shi (JP); Kazuo Saito, Okazaki-shi (JP)

Correspondence Address: BIRCH STEWART KOLASCH & BIRCH, PO BOX 747, FALLS CHURCH, VA, 22040-0747, US

(21) Appl. No.: 10/638,373

(22) Filed: Aug. 12, 2003

(30) Foreign Application Priority Data
Aug. 12, 2002 (JP) 2002-234667

(51) Int. Cl. H01M 8/00

(52) U.S. Cl. 429/12; 264/319

(57) ABSTRACT

A fuel cell separator having hydrophilic areas and water-repelling areas is manufactured by selectively charging a hydrophilic molding material and a water-repellent molding material into a mold and integrally compression molding the charged materials. The process can be used for the low-cost, high-volume production of fuel cell separators. Even separators having a complex channel geometry can be easily and selectively conferred with hydrophilicity and water-repellency, and can be provided with a uniform density and uniform pores.

### BACKGROUND OF THE INVENTION

1. Field of the Invention

The present invention relates to a method of manufacturing fuel cell separators. The invention also relates to fuel cell separators obtained by this method.

2. Prior Art

Fuel cells are devices which, when supplied with a fuel such as hydrogen and with atmospheric oxygen, cause the fuel and oxygen to react electrochemically, producing water and directly generating electricity. Because fuel cells are capable of achieving a high fuel-to-energy conversion efficiency and are environmentally friendly, they are being developed for a variety of applications, including small-scale local power generation, household power generation, simple power supplies for isolated facilities such as campgrounds, mobile power supplies such as for automobiles and small boats, and power supplies for satellites and space development.

Such fuel cells, and particularly solid polymer fuel cells, are built in the form of modules composed of a stack of at least several tens of unit cells. Each unit cell has a pair of plate-like separators with raised and recessed areas on either side thereof that define a plurality of channels for the flow of gases such as hydrogen and oxygen. Disposed between the pair of separators in the unit cell are a solid polymer electrolyte membrane and gas diffusing electrodes made of carbon paper.

The role of the fuel cell separators is to confer each unit cell with electrical conductivity, to provide flow channels for the supply of fuel and air (oxygen) to the unit cells, and to serve as a separating boundary membrane. Characteristics required of the separators include high electrical conductivity, high gas impermeability, electrochemical stability and hydrophilic properties.

In particular, the separators must be capable of rapidly removing the water that forms from the reaction of the gases and strongly affects the characteristics and performance of the fuel cell. It is especially important for the hydrophilic properties of the separator to be enhanced.

Such fuel cell separators are produced in a number of different ways. One prior-art process involves the use of a machining operation to cut channels in a plate of porous fired carbon. In another process, described in U.S. Pat. No. 6,187,466, a slurry prepared from graphite powder, binder resin and cellulose fibers is formed into a sheet by a papermaking process, following which the sheet is graphitized. Because separators made of these materials have poor hydrophilic properties, they are typically treated to impart the largely carbon separator surfaces with hydrophilic properties. Examples of such treatments include oxidation treatment, plasma treatment and ultraviolet treatment.

U.S. Pat. No. 5,840,414 describes a process in which a hydrophilic metal oxide film is formed on a separator surface under high-temperature, alkaline conditions Even as techniques for conferring fuel cell separators with hydrophilic properties continue to be investigated, attempts are also being made to impart separators with water-repelling properties. To date, these latter efforts have led to the development of, for example, a method for gold plating the separator surface (JP-A 9-298064) and methods of coating the separator surface with fluorocarbon resins.

However, in prior-art separator manufacturing methods, graphitization leads to increased costs. The use of a machining operation to cut channels takes more time and is more costly, and also results in a lower yield. Moreover, cutting is poorly suited to the production of fuel cell separators having a complex channel geometry.

Also, hydrophilic treatment administered by oxidation treatment lowers the strength of the separator plate. The application of plasma treatment or ultraviolet treatment compromises the durability of the hydrophilic properties. Methods that involve the formation of a hydrophilic metal oxide film under high-temperature, alkaline conditions must be carried out in a special environment and are thus not generally applicable, in addition to which they are unsuitable for molded carbon separators.

Known treatment methods for conferring the separator with water repellency include plating the separator surface with gold and coating the separator surface with a fluorocarbon resin. However, both of these processes lead to increased costs.

### SUMMARY OF THE INVENTION

It is therefore one object of the invention to provide a method that lends itself well to the low-cost, high-volume production of fuel cell separators which, even when of a complex channel geometry, can easily be conferred with hydrophilicity and water repellency and can also be endowed with a uniform density and uniform pores. Another object of the invention is to provide fuel cell separators obtained by this method.

We have discovered that, in a process for manufacturing fuel cell separators having hydrophilic areas and water-repelling areas that involves charging a hydrophilic molding material and a water-repellent molding material into a compression mold and compression molding the charged materials, by charging the hydrophilic molding material for the hydrophilic areas of the separator, charging the water-repellent molding material for the water-repelling areas of the separator and integrally molding the charged materials, even separators having a complex channel geometry can easily be conferred at required places thereon with hydrophilicity and water-repellency and can also be readily provided with a uniform density and uniform pores.

Accordingly, the invention provides a method of manufacturing a fuel cell separator having hydrophilic areas and water-repelling areas, which method includes charging a hydrophilic molding material and a water-repellent molding material into a compression mold and compression molding the charged materials. The hydrophilic molding material is charged for the hydrophilic areas of the separator, the water-repellent molding material is charged for the water-repelling areas of the separator, and the charged materials are integrally molded.

In one preferred embodiment of the invention, the separator has gas flow channels defined by channel faces, the hydrophilic molding material is charged for part or all of the channel faces, and the water-repellent molding material is charged for other areas of the separator.

In another preferred embodiment, the hydrophilic molding material and the water-repellent molding material are charged onto a transfer surface of the compression mold so as to form two layers in an arrangement consisting of a hydrophilic molding material layer and a water-repellent molding material layer.

In yet another preferred embodiment, the hydrophilic molding material and the water-repellent molding material are charged onto a transfer surface of the compression mold so as to form three layers in a hydrophilic material layer/water-repellent material layer/hydrophilic material layer arrangement.

In still another preferred embodiment, the hydrophilic molding material and the water-repellent molding material are charged in varying amounts for areas of differing volume on the fuel cell separator.

The fuel cell separator generally has a density variation of less than 5% and may be porous. If the separator is porous, the porosity is preferably from 1 to 50% and the pressure applied during compression molding of the separator is 0.98 to 14.7 MPa.

The invention additionally provides a fuel cell separator obtained by the foregoing fuel cell manufacturing method.

### BRIEF DESCRIPTION OF THE DIAGRAMS

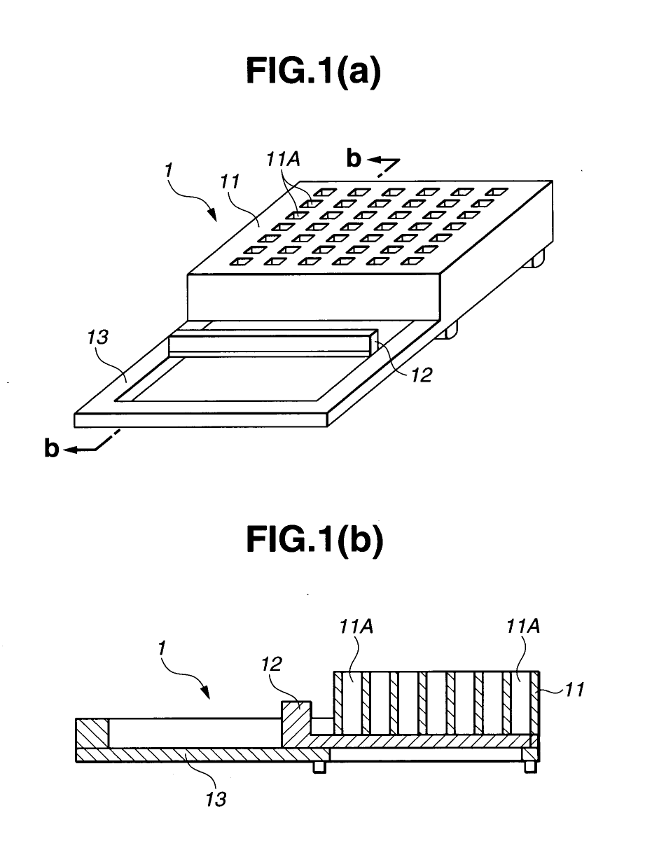

FIG. 1 illustrates a charging device such as may be used according to one embodiment of the invention. FIG. 1a is a perspective view of the device, and FIG. 1b is a sectional view taken along line b-b in FIG. 1a.

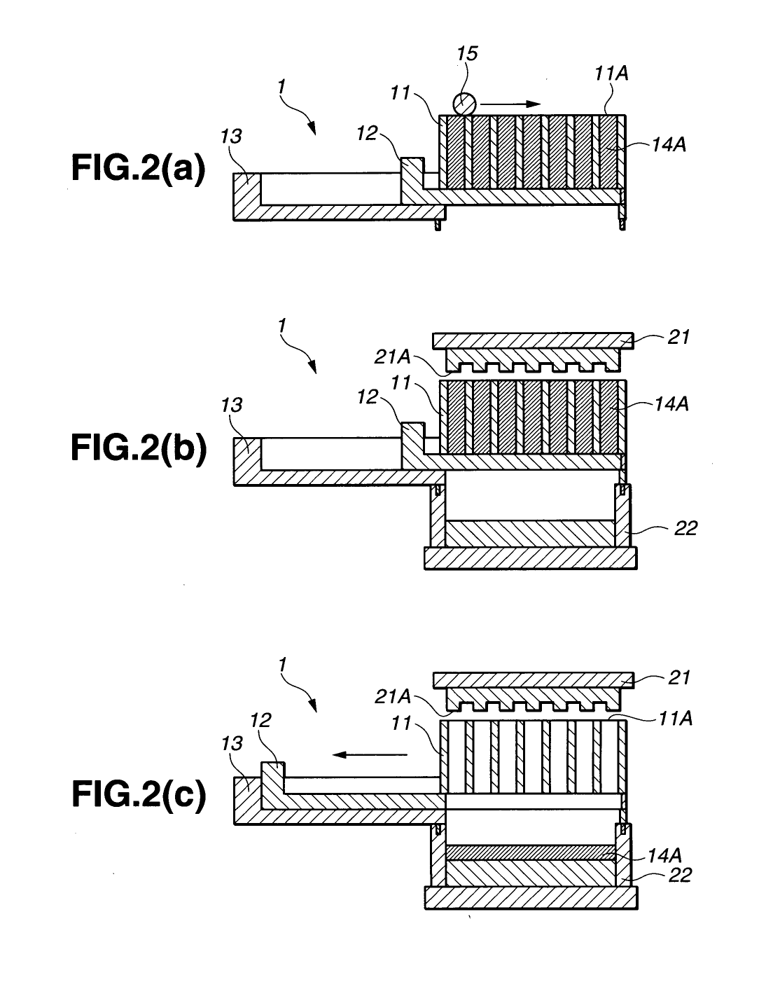

FIG. 2 shows schematic sectional views of individual steps involved in charging the water-repellent molding material according to the same embodiment of the invention.

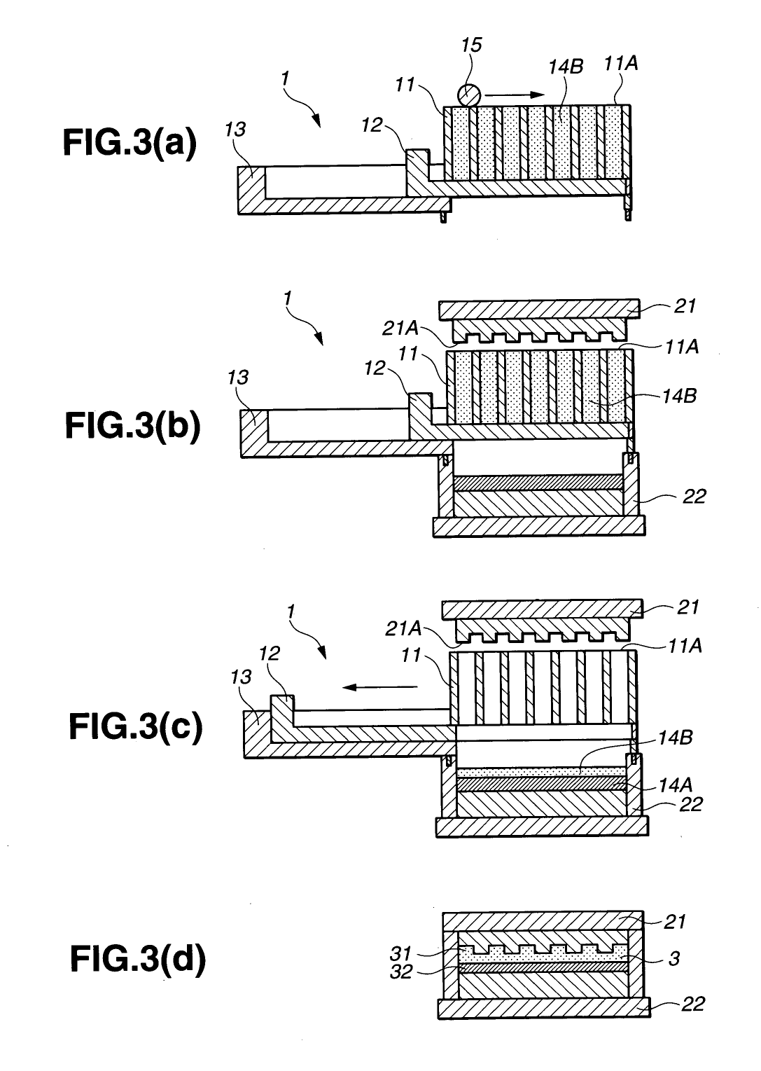

FIG. 3 shows schematic sectional views of individual steps, from charging of the hydrophilic molding material to compression, according to the same embodiment of the invention.

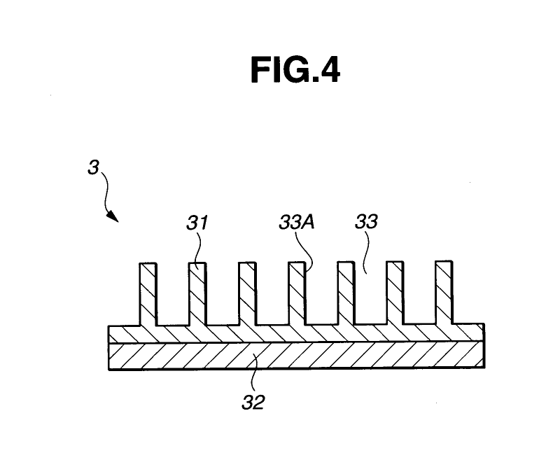

FIG. 4 is a schematic sectional view showing the fuel cell separator obtained in the same embodiment of the invention.

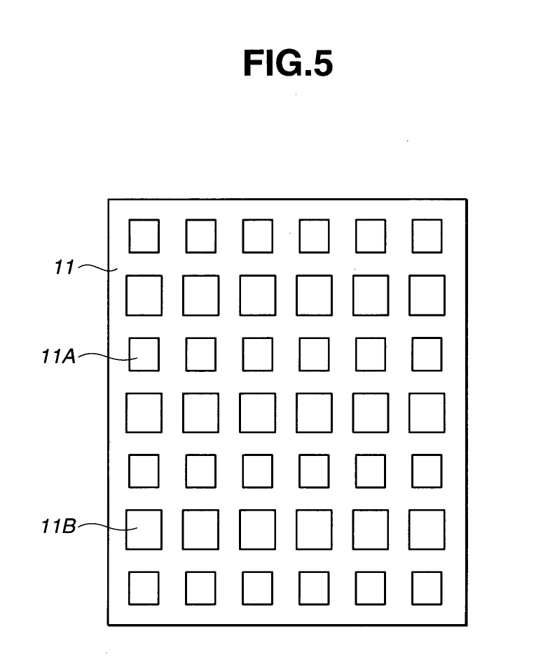

FIG. 5 is a top view showing the charging member of a charging device such as may be used in another embodiment of the invention.

### DETAILED DESCRIPTION OF THE INVENTION

The objects, features and advantages of the invention will become more apparent from the following detailed description, taken in conjunction with the foregoing diagrams.

As noted above, the present invention provides a method of manufacturing fuel cell separators having hydrophilic areas and water-repelling areas that involves charging a hydrophilic molding material and a water-repellent molding material into a compression mold, and compression molding the charged materials. The hydrophilic molding material is charged for the hydrophilic areas of the separator, the water-repellent molding material is charged for the water-repelling areas of the separator, and the charged materials are integrally molded.

The hydrophilic molding material and the water-repellent molding material used in the method of the invention may each be composed primarily of any material commonly employed in the production of fuel cell separators, including materials prepared by subjecting a mixture of electrically conductive powder and resin to a compounding operation.

The electrically conductive powder is not subject to any particular limitation. Illustrative examples include natural graphite, synthetic graphite and expanded graphite. The conductive powder has an average particle size in a range of preferably about 10 to 100 μm, and most preferably 20 to 60 μm.

The resin may be suitably selected from among thermoset resins, thermoplastic resins and other resins commonly used in fuel cell separators. Specific examples of resins that may be used include phenolic resins, epoxy resins, acrylic resins, melamine resins, polyamide resins, polyamideimide resins, polyetherimide resins and phenoxy resins. If necessary, these resins may be heat treated.

No limitation is imposed on the proportions in which the conductive powder and the resin are blended, although it is desirable for both the hydrophilic molding material and the water-repellent molding material to include, per 100 parts thereof: 50 to 99 parts by weight, and especially 65 to 90 parts by weight, of the conductive powder; and 1 to 50 parts by weight, and especially 5 to 20 parts by weight, of the resin.

The hydrophilic molding material may be used directly in the form of a composition obtained by mixing together the conductive powder and the resin, although it preferably includes also, for example, a water-absorbing porous substances, such as activated carbon or activated alumina, or a hydrophilic substance such as a fine powder of titanium oxide or tin oxide. The water-absorbing porous substance is preferably one which does not swell upon absorbing water and contains no leachable components.

These hydrophilic components are typically included in an amount, based on the foregoing composition, of 0.1 to 20 parts by weight, and preferably 1 to 10 parts by weight. At more than 20 parts by weight, the electrical resistance of the separator may increase. On the other hand, the inclusion of too little hydrophilic component may fail to provide a hydrophilic effect.

The water-repellent molding material used in the invention is obtained by incorporating a substance which confers water repellency to a composition made up of the above electrically conductive powder and resin. The substance which confers water-repellency is not subject to any particular limitation. Illustrative examples include known water-repellent substances such as various water-repellent fillers (e.g., fluorocarbon resins, waxes, natural graphite).

These water-repellent substances may be used in any suitable amount, although the use of 0.1 to 20 parts by weight, and especially 1 to 10 parts by weight, based on the foregoing composition, is preferred. At less than 0.1 part by weight, the water-repellent molding material may fail to exhibit adequate water repellency. On the other hand, at more than 20 parts by weight, the strength of the separator may decline and its electrical resistance may rise.

Both the hydrophilic molding material and the water-repellent molding material may include also 1 to 20 parts by weight, and preferably 1 to 10 parts by weight, of any of various types of fibers, such as carbon fibers, organic fibers or inorganic fibers, to provide increased strength.

In the practice of the invention, the above-described hydrophilic molding material and water-repellent molding material are typically used after being separately compounded by any suitable method. Compositions of the above ingredients that have been subsequently stirred, granulated and dried by known methods may be used, although it is preferable for each of these molding materials to be a compounded material which has been screened to prevent secondary agglomeration and adjusted to a specific particle size. Each of the above molding materials has an average particle size which varies with the particle size of the conductive powder used, but is preferably at least 60 μm. The particle size distribution is preferably from 10 μm to 2.0 mm, more preferably from 30 μm to 1.5 mm, and most preferably from 50 μm to 1.0 mm.

It is desirable for the hydrophilic molding material and the water-repellent molding material to have about the same particle size distribution in order for them to have about the same bulk density when charged into the mold.

Moreover, it is advantageous for both molding materials to have about the same moisture content in order for them to have a uniform dispersibility when they are charged into the mold. The moisture content is preferably 0 to 5%, and most preferably 0.5 to 3%.

The hydrophilic molding material is charged for the hydrophilic areas of the fuel cell separator being manufactured and the water-repellent molding material is charged for the water-repelling areas. In particular, when the fuel cell separator has gas flow channels, it is preferable for the hydrophilic molding material to be charged for part or all of the flow channel faces defining those flow channels and for the water-repellent molding material to be charged for other areas of the separator.

In this way, at least a portion of the gas flow channel faces in the resulting fuel cell separator become hydrophilic areas. Because water that forms during power generation is absorbed at these places, such water can be prevented from obstructing the gas flow channels.

Charging of the hydrophilic molding material and the water-repellent molding material into the compression mold is preferably carried out in such a way as to form two layers in a hydrophilic material layer/water-repellent material layer arrangement or a water repellent material layer/hydrophilic material layer arrangement on a transfer surface of the mold. In order for the fuel cell separator to have as uniform an ability to absorb water that forms during power generation as possible, it is desirable for each layer to be parallel to the transfer surface.

Alternatively, the respective materials may be charged so as to form three layers in a hydrophilic material layer/water-repellent material layer/hydrophilic material layer arrangement. Here too, for the same reason as given above, it is desirable for each layer to be formed parallel to the transfer surface.

By using a method that charges the respective molding materials in a layered arrangement onto the transfer surface of the mold in the above fashion, hydrophilic areas and water-repelling areas can easily and reliably be formed on the fuel cell separator, thereby imparting the separator with a uniform ability to absorb water that forms during power generation and making it possible to minimize disparities in power generation within the plane of the separator.

It is also advantageous, when charging the hydrophilic molding material and the water-repellent molding material, to charge the respective materials in varying amounts for areas of differing volume on the fuel cell separator.

“Areas of differing volume,” as used herein, refers to areas of differing compressibility during molding. That is, the fuel cell separator is manufactured by charging large relative amounts of each molding material for large volume areas (areas of low compressibility) on the separator and charging small relative amounts of each molding material for small volume areas (areas of high compressibility).

The areas of differing volume at this time are preferably recessed areas (channels) and raised areas (ribs) formed on the fuel cell separator. In such a case, small relative amounts of each molding material are charged to form the recessed areas, and large relative amounts of each molding material are charged to form the raised areas.

By varying in this way the amount in which each molding material is charged for recessed areas and raised areas of the separator, density differences between the recessed areas of high compressibility and the raised areas of low compressibility can easily be prevented, facilitating the production of fuel cell separators of uniform density and uniform pore size.

The pressure applied during compression molding is not subject to any particular limitation, and may be set as appropriate for the required density of the separator being manufactured. The molding pressure is generally from 0.098 to 19.6 MPa, preferably from 0.98 to 14.7 MPa, and most preferably from 1.96 to 9.8 MPa. At a molding pressure of less than 0.098 MPa, a strength sufficient to maintain the shape of the fuel cell separator may not be achieved. On the other hand, at a pressure greater than 19.6 MPa, strain may arise in the molding machine and mold, lowering the planar and dimensional precision of the resulting fuel cell separator.

It is desirable for fuel cell separators manufactured as described above to have a density variation of less than 5%, preferably less than 3%, and most preferably less than 2%. “Density variation,” as used herein, refers to the variation in density, as computed from weight and volume measurements, at different places on the fuel cell separator.

At a density variation of 5% or more, the fuel cell separator may undergo local decreases in strength and may exhibit variations in electrical resistance and heat conductivity.

In cases where the fuel cell separator produced by the method of the invention is given a porous construction, it is advantageous for the pores to have a diameter of 0.01 to 50 μm and for the porosity to be 1 to 50%, and preferably 10 to 30%.

At a pore diameter smaller than 0.01 μm, water produced during power generation by the fuel cell passes through the separator with greater difficulty and may obstruct the gas flow channels. On the other hand, at a pore diameter larger than 50 μm, precise formation of the channel geometry may not be possible.

At a porosity of less than 1%, the ability to absorb water that forms during power generation decreases, which may result in obstruction of the gas flow channels. On the other hand, at a porosity of more than 50%, precise formation of the channel geometry may be impossible.

When a porous fuel cell separator is produced by the inventive method, the molding pressure is preferably from 0.98 to 14.7 MPa. At less than 0.98 MPa, the strength of the resulting separator may decline. On the other hand, at a pressure greater than 14.7 MPa, the pores may become filled, increasing the possibility that a porous separator cannot be achieved.

Fuel cell separators obtained by the method of the invention can, if necessary, be subjected to hydrophilizing treatment that involves treating the separator with a known hydrophilic substance by a suitable technique such as impregnation, spraying or dipping. Of these treatment techniques, the use of impregnation is preferred because it enables better penetration of the hydrophilic substance into hydrophilic areas of the separator. Impregnation treatment at a reduced pressure of from −0.06 to −0.1 MPa is especially preferred.

Because the water-repelling areas are not affected by such hydrophilizing treatment, no post-treatment is required.

Any suitable hydrophilic substance may be used in the foregoing hydrophilizing treatment. Preferred examples include Denacol EX 1310, Denacol EX 1610 and Denacol EX 861 (all made by Nagase ChemteX Corporation); Dicfine EN-0270 (made by Dainippon Ink & Chemicals, Inc.); and SR-8EG and SR-4PG (both made by Sakamoto Yakuhin Kogyo Co., Ltd.). The hydrophilic substance can be used in the above impregnation treatment in the form of an aqueous solution prepared by dissolution in water to a concentration of 0.1 to 99 wt %.

If the hydrophilic substance is added beforehand to the hydrophilic molding material, this will have the desirable effect of encouraging infiltration of the hydrophilic substance into the interior of the pores during hydrophilizing treatment.

In the practice of the invention, any suitable method may be used to charge the respective above-described molding materials into the compression mold provided the molding materials are charged selectively for the hydrophilic areas and the water-repelling areas of the fuel cell separator being manufactured. For example, use may be made of a device for charging powdered molding material like that shown in FIG. 1.

Referring to FIG. 1, the charging device 1 has a charging member 11, a slide plate 12 situated below the charging member 11, and a base 13 which is integrally molded with the charging member 11 and forms an outside border that encloses the slide plate 12.

The charging member 11 has charging holes 11A of substantially rectangular shape, which holes 11A are arranged as a matrix of evenly spaced rows and columns. The charging holes 11A pass vertically through the charging member, are open at the bottom, and have a bore which can be selected as appropriate for the separator.

It has already been noted above that the base 13 is formed integrally with the charging member 11. In addition, as shown in FIG. 1b, the portion of the base 13 over which the charging holes 11A are situated is hollow.

The base 13 and the charging member 11 have formed therebetween a gap of a given size, within which the slide plate 12 is disposed so as to be freely slideable.

The slide plate 12 is designed so as to be freely movable from a condition in which the bottoms of the charging holes 11A are closed to a condition in which they are open.

Charging of the powdered molding materials into a compression mold using a charging device 1 of the foregoing construction and compression molding may be carried out as follows.

As shown in FIG. 2a, a water-repellent molding material 14A for the water-repelling areas of the separator is charged into the charging holes 11A in the charging member 11, then is leveled off with a leveling rod 15, thereby filling the holes 11A with predetermined amounts of the water-repelling material 14A.

Next, as shown in FIG. 2b, the charging device 1 filled with the water-repellent molding material 14A is set on the bottom half 22 of a compression mold in a press having a top mold half 21 and bottom mold half 22. The top half 21 bears a pattern 21A for forming gas flow channels on the fuel cell separator.

It is also possible in this case to place a preform on the bottom half 22 of the mold.

After the charging device 1 has been set on the bottom half 22 of the mold, as shown in FIG. 2c, the slide plate 12 is moved to the left side in the diagram so as to open the bottoms of the charging holes 11A, allowing the water-repellent molding material 14A filled into the holes to fall onto the bottom half 22 of the mold. The slide plate 12 is then returned to its original position.

Next, as shown in FIG. 3, the hydrophilic molding material 14B is similarly filled into the charging holes 11A.

Referring to FIG. 3c, the slide plate 12 is again slid to the left in the diagram so as to open the bottoms of the charging holes 11A, allowing the hydrophilic molding material 14B filled into the holes to fall onto the water-repellent molding material 14A that was earlier charged.

The two charging operations result in the formation, within the bottom mold half 22, of two layers: a bottom layer of water-repellent molding material 14A that has been charged parallel to the transfer surface of the bottom half 22, and a top layer of hydrophilic molding material 14B that has been charged thereon, also parallel to the transfer surface By subsequently clamping the mold shut with the top half 21 thereof (FIG. 3d) and compression molding at a mold temperature of, say, 100 to 250° C., and preferably 140 to 200° C., and a molding pressure of 0.98 to 19.6 MPa, there can be obtained a fuel cell separator 3 in which, as shown in FIG. 4, the areas surrounding the flow channel surfaces 33A of the gas flow channels 33 are hydrophilic areas 31 and the other areas are water-repelling areas 32.

The order in which the hydrophilic molding material and the water-repellent molding material are charged is not limited to that in the foregoing embodiment; that is, the hydrophilic molding material may be charged first. Moreover, although a two-layer arrangement composed of a hydrophilic material layer and a water-repellent material layer is formed within the mold in the above embodiment, it is possible instead to charge the respective materials in such a way as to form three layers in a hydrophilic material layer/water-repellent material layer/hydrophilic material layer arrangement, or even to charge the respective materials so as to form more than three layers.

In the above-described embodiment, the bottom half 22 of the mold has no pattern for forming gas flow channels. However, the bottom mold half 22 may also be provided with a gas flow channel-forming pattern, in which case a fuel cell separator having gas flow channels on both surfaces can be obtained.

The molding materials can each be charged in varying amounts for areas of differing volume on the separator, such as gas flow channels. In such cases, use can be made of a method in which the above-described charging device is employed to charge the molding materials a plurality of times only in required places. Alternatively, a method may be employed that varies the amounts of the respective materials charged using a charging device 11 having first charging holes 11A and second charging holes 11 B of different bores, as shown in FIG. 5.

As described above, the present invention enables the low-cost, high-volume production of fuel cell separators which, even when possessing a complex channel geometry, can easily be conferred in required places with hydrophilic properties and water-repelling properties and which have a uniform density and uniform pores. Moreover, because the method of the invention is capable of molding channel-bearing plates, it eliminates the need for machining operations and requires no firing step, thus making it possible to reduce production costs.

If a hydrophilic substance is included beforehand in the hydrophilic molding material, the hydrophilic areas of the fuel cell separator can be made hydrophilic to the interior of the pores therein, thus increasing water absorptivity, water permeability and water retention in the separator.

Even in cases where hydrophilic treatment is required after molding, the water-repelling areas are not affected by such hydrophilic treatment. Accordingly, hydrophilic treatment can easily be administered, making it possible to adjust the degree of hydrophilicity in the hydrophilic areas, if necessary.

Fuel cell separators obtained by the manufacturing method of the invention as described above are highly suitable for use as separators in solid polymer fuel cells.

### EXAMPLES

The following examples and comparative examples are provided to illustrate the invention and are not intended to limit the scope thereof. Average particle sizes given below were measured using a Microtrak particle size analyzer.

### Example 1

A hydrophilic molding material was prepared by mixing 90 parts by weight of artificial graphite powder having an average particle size of 60 μm and 10 parts by weight of phenolic resin to form a composition, granulating and drying the composition, then screening the dried material so as to adjust the particle size to 0.5 to 1.0 mm.

A water-repellent molding material was prepared by mixing 90 parts by weight of artificial graphite powder having an average particle size of 60 μm, 9 parts by weight of phenolic resin and 1 part by weight of a water-repelling ingredient (carnauba wax made by Dainichi Kagaku Kogyo KK) to form a composition, granulating and drying the composition, then screening the dried material so as to adjust the particle size to 0.5 mm or less.

The water-repellent molding material 14A was charged into the charging holes 11A of the charging device 1 shown in FIGS. 1 to 3, and leveled off with a leveling rod 15 to fill each hole. Next, a slide plate 12 was slid so as to open the bottom of the charging holes 11A, thereby charging the water-repellent molding material 14A onto the bottom half 22 of a compression mold.

In this example, there were a total of 36 charging holes 11A, each having a cross-sectional size of 15×15 mm.

Next, as shown in FIG. 3, the hydrophilic molding material 14B was charged into the charging holes 11A in the same way as just described. The slide plate 12 was then slid again so as to open the bottom of the charging holes 11A, thereby allowing the hydrophilic molding material 14B filled therein to fall onto the earlier charged water-repellent molding material 14A.

As shown in FIG. 3c, these two charging operations resulted in the interior of the bottom half 22 of the mold being charged first with the water-repellent molding material 14A as a layer parallel to the transfer surface of the bottom mold half 22, then being charged with the hydrophilic molding material 14B, also as a layer parallel to the transfer surface.

The top half 21 of the mold was then clamped shut over the bottom half 22 and compression molding was carried out at a mold temperature of 170° C. and a molding pressure of 10 MPa to form a fuel cell separator 3 in which, as shown in FIG. 4, the areas surrounding the surfaces 33A of the gas flow channels 33 were hydrophilic areas 31 and the other areas were water-repelling areas 32.

A 3 wt % aqueous solution of Denacol EX-1310 (produced by Nagase ChemteX Corporation) was prepared, and the solution was impregnated into the separator obtained above under a reduced pressure of -0.09 MPa.

### Example 2

A hydrophilic molding material was prepared by mixing 75 parts by weight of artificial graphite powder having an average particle size of 60 μm, 15 parts by weight of phenolic resin and 10 parts by weight of activated carbon to form a composition, granulating and drying the composition, then screening the dried material so as to adjust the particle size to 0.5 mm or less.

A water-repellent molding material was prepared in the same way as in Example 1.

The hydrophilic molding material and the water-repellent molding material were used to obtain a fuel cell separator 3 in the same way as in Example 1. The separator 3 was then subjected to hydrophilizing treatment as in Example 1.

### Example 3

A hydrophilic molding material was prepared by mixing 80 parts by weight of artificial graphite powder having an average particle size of 60 μm, 10 parts by weight of phenolic resin and 10 parts by weight of activated alumina to form a composition, granulating and drying the composition, then screening the dried material so as to adjust the particle size to 0.5 mm or less.

A water-repellent molding material was prepared in the same way as in Example 1.

The hydrophilic molding material and the water-repellent molding material were used to obtain a fuel cell separator 3 in the same way as in Example 1. The separator 3 was then subjected to hydrophilizing treatment as in Example 1.

### Example 4

A hydrophilic molding material was prepared by mixing 75 parts by weight of artificial graphite powder having an average particle size of 60 μm, 15 parts by weight of phenolic resin and 10 parts by weight of carbon fibers to form a composition, granulating and drying the composition, then screening the dried material so as to adjust the particle size to 0.5 mm or less.

A water-repellent molding material was prepared in the same way as in Example 1.

The hydrophilic molding material and the water-repellent molding material were used to obtain a fuel cell separator 3 in the same way as in Example 1. The separator 3 was then subjected to hydrophilizing treatment as in Example 1.

### Example 5

A hydrophilic molding material was prepared in the same way as in Example 1.

A water-repellent molding material was prepared by mixing 90 parts by weight of artificial graphite powder having an average particle size of 60 μm and 10 parts by weight of a fluorocarbon resin to form a composition, granulating and drying the composition, then screening the dried material so as to adjust the particle size to 0.5 mm or less.

The hydrophilic molding material and the water-repellent molding material were used to obtain a fuel cell separator 3 in the same way as in Example 1. The separator 3 was then subjected to hydrophilizing treatment as in Example 1.

### Example 6

A hydrophilic molding material was prepared in the same way as in Example 1.

A water-repellent molding material was prepared by mixing 90 parts by weight of artificial graphite powder having an average particle size of 60 μm, 8 parts by weight of phenolic resin and 2 parts of a fluorocarbon resin to form a composition, granulating and drying the composition, then screening the dried material so as to adjust the particle size to 0.5 mm or less.

The hydrophilic molding material and the water-repellent molding material were used to obtain a fuel cell separator 3 in the same way as in Example 1. The separator 3 was then subjected to hydrophilizing treatment as in Example 1.

### Comparative Example 1

A hydrophilic molding material was prepared in the same way as in Example 1. Only this hydrophilic molding material was used in the present example.

The hydrophilic molding material was charged into the charging holes 11A of the charging device 1 shown in FIGS. 1 and 2, then leveled off with a leveling rod 15 so as to fill each hole. The slide plate 12 was then moved toward the left in FIG. 2, thereby opening the bottoms of the charging holes 11A and charging the hydrophilic molding material onto the bottom half 22 of a compression mold.

The top half 21 of the mold was subsequently clamped shut over the bottom half 22, and compression molding was carried out at 170° C. and 10 MPa to form a fuel cell separator having only hydrophilic areas.

### Comparative Example 2

A water-repellent molding material was prepared in the same way as in Example 1. Only this water-repellent molding material was used in the present example.

The water-repellent molding material was charged into the charging holes 11A of the charging device 1 shown in FIGS. 1 and 2, then leveled off with a leveling rod 15 so as to fill each hole. The slide plate 12 was then moved toward the left in FIG. 2, thereby opening the bottoms of the charging holes 11A and charging the water-repellent molding material onto the bottom half 22 of a compression mold.

The top half 21 of the mold was subsequently clamped shut over the bottom half 22, and compression molding was carried out at 170° C. and 10 MPa to form a fuel cell separator having only water-repelling areas.

### Comparative Example 3

Both a hydrophilic molding material and a water-repellent molding material were prepared in the same way as in Example 1. These materials were premixed in a 1:1 weight ratio to form a combined molding material.

The combined molding material was charged into the charging holes 11A of the charging device 1 shown in FIGS. 1 and 2 , then leveled off with a leveling rod 15 so as to fill each hole. The slide plate 12 was then moved toward the left in FIG. 2, thereby opening the bottoms of the charging holes 11A and charging the combined molding material onto the bottom half 22 of a compression mold.

The top half 21 of the mold was subsequently clamped shut over the bottom half 22, and compression molding was carried out at 170° C. and 10 MPa to form a fuel cell separator.

The fuel cell separators obtained in the above examples and comparative examples were subjected to measurements of water absorption time in hydrophilic areas, contact angle in water-repelling areas, and the following separator properties: porosity, density variation, specific resistance, contact resistance, flexural strength and flexural modulus. The measurement methods are described below and the results are given in Table 1.

1. Water Absorption Time in Hydrophilic Areas

The fuel cell separator was placed in a constant temperature tank set at 80% humidity, 0.0025 g of ion-exchanged water was deposited on the surface of the separator, and the time it took for the water to be absorbed by the separator surface was measured.

2. Contact Angle in Water-Repelling Areas

A drop of ion-exchanged water was deposited with a dropping pipette onto the surface of a flat-lying separator, and the angle of the separator surface with the water was measured with a FACE contact angle meter (model CA-D, manufactured by Kyowa Interface Science Co., Ltd.).

3. Porosity

Measured by mercury injection porosimetry.

4. Density Variation

Five areas on a separator were selected at random and cut out, and the density of each was determined. The variation in density was calculated as the difference between the maximum and minimum density values obtained.

5. Specific Resistance

Measured by the four-probe method described in JIS H-0602.

6. Contact Resistance:

The separator was placed between two smooth, gold-plated copper plates, and the contact resistance was measured from the voltage drop across the plates when a constant current was passed through.

7. Flexural Strength, Flexural Modulus

Measured in general accordance with the method described in ASTM D790.

TABLE 1

| | | Contact | | | | | | |
|---|---|---|---|---|---|---|---|---|
| | Water | angle | | | | | | |
| | absorption | with water | | | | | | |
| | time in | in water- | | | | | | |
| | hydrophilic | repelling | | Density | Specific | Contact | Flexural | Flexural |
| | areas | areas | Porosity | variation | resistance | resistance | strength | modulus |
| | (seconds) | (degrees) | (%) | (%) | (mQ · cm) | (mQ · cm²) | (MPa) | (GPa) |
| Example 1 | 60 | 160 | 22 | 1 | 7.6 | 3.9 | 27 | 13 |
| Example 2 | 5 | 160 | 25 | 1 | 15 | 10 | 14 | 10 |
| Example 3 | 4 | 160 | 24 | 1 | 9 | 4.2 | 18 | 11 |
| Example 4 | 40 | 160 | 15 | 1 | 9.5 | 5.1 | 32 | 16 |
| Example 5 | 70 | 164 | 22 | 1 | 11 | 5.2 | 17 | 9 |
| Example 6 | 60 | 155 | 22 | 1 | 10.5 | 4.5 | 20 | 10 |
| Comparative | >15 minutes | 125 | 22 | 1 | 7.9 | 3.8 | 27 | 14 |
| Example 1 | | | | | | | | |
| Comparative | >15 minutes | 135 | 22 | 1 | 8.1 | 4.0 | 25 | 14 |
| Example 2 | | | | | | | | |
| Comparative | >15 minutes | 125 | 22 | 1 | 7.5 | 3.9 | 27 | 13 |
| Example 3 | | | | | | | | |

The results in Table 1 show that the fuel cell separators obtained in each of the examples according to the invention had excellent water absorbing properties in the hydrophilic areas and excellent water-repellency in the water-repelling areas. Moreover, the other measured properties for these separators, including specific resistance, contact resistance, flexural strength and flexural modulus, were all good.

As described and demonstrated above, in the fabrication of a fuel cell separator having hydrophilic areas and water-repelling areas by the method of the invention, a hydrophilic molding material is charged for the hydrophilic areas of the separator and a water-repellent molding material is charged for the water-repelling areas of the separator. As a result, even separators having a complex channel geometry can easily be conferred in the necessary places with hydrophilic properties and water repellency. Moreover, the separator can easily be provided with a uniform density and uniform pores.

Japanese Patent Application No. 2002-234667 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method of manufacturing a fuel cell separator having hydrophilic areas and water-repelling areas, the method being comprised of charging a hydrophilic molding material and a water-repellent molding material into a compression mold, and compression molding the charged materials:
wherein the hydrophilic molding material is charged for the hydrophilic areas of the separator, the water-repellent molding material is charged for the water-repelling areas of the separator, and the charged materials are integrally molded.

2. The method of claim 1, wherein the separator has gas flow channels defined by channel faces, the hydrophilic molding material is charged for at least part of the channel faces, and the water-repellent molding material is charged for other areas of the separator.

3. The method of claim 1, wherein the hydrophilic molding material and the water-repellent molding material are charged onto a transfer surface of the compression mold so as to form two layers in an arrangement consisting of a hydrophilic molding material layer and a water-repellent molding material layer.

4. The method of claim 1, wherein the hydrophilic molding material and water-repellent molding material are charged onto a transfer surface of the compression mold so as to form three layers in a hydrophilic material layer/water-repellent material layer/hydrophilic material layer arrangement.

5. The method of claim 1, wherein the hydrophilic molding material and the water-repellent molding material are charged in differing amounts for areas of differing volume on the fuel cell separator.

6. The method of claim 1, wherein the fuel cell separator has a density variation of less than 5%.

7. The method of claim 1, wherein the fuel cell separator is porous.

8. The method of claim 7, wherein the fuel cell separator has a porosity of 1 to 50%.

9. The method of claim 7, wherein the pressure during compression molding is 0.98 to 14.7 MPa.

10. A fuel cell separator obtained by the fuel cell manufacturing method of claim 1.
